(19) United States
(12) Patent Application Publication
(10) Pub. No.: US 2014/0158806 A1
(43) Pub. Date: Jun. 12, 2014

(54) METHOD FOR RETRACTING A SEAT BELT

(71) Applicant: Volvo Car Corporation, Goteborg (SE)

(72) Inventor: Peter Harda, Torslanda (SE)

(73) Assignee: Volvo Car Corporation, Goteborg (SE)

(21) Appl. No.: 14/103,623

(22) Filed: Dec. 11, 2013

(30) Foreign Application Priority Data
Dec. 12, 2012 (EP) 12196734.3

(51) Int. Cl. B60R 22/46

(52) U.S. Cl. CPC B60R 22/46
USPC 242/384

(57) ABSTRACT

A method for retracting a seat belt of a vehicle includes determining an excessive length of seat belt pulled out as the difference between the current length and the minimum length of seat belt pulled out, when the seat belt is in use. The method further includes, if a collision or and/or a risk situation involving the vehicle is detected, retracting the seat belt by applying a retraction force, the retraction force being a function of the excessive length of seat belt pulled out. Further, a safety arrangement of a vehicle includes a seat belt, a first sensor for determining an excessive length of seat belt pulled out, a collision detection system, a retractor for retracting the seat belt by applying the retraction force, and a processor for determining the retraction force as a function of the excessive length of seat belt pulled out.

### CROSS REFERENCE TO RELATED APPLICATIONS

The present application claims priority to European Patent Application No. 12196734.3, filed on Dec. 12, 2012, the entire contents of which are hereby incorporated by reference for all purposes.

### TECHNICAL FIELD

The present disclosure relates to a method for retracting a seat belt of a vehicle. The disclosure further relates to a safety arrangement of a vehicle.

### BACKGROUND

A modern vehicle, such as a car, is provided with safety arrangements in order to prevent or avoid injury to the seat occupant of the vehicle in case of an accident. It is well-known to use a safety arrangement comprising a seat belt for restraining the movement of the seat occupant in case of a sudden change of speed of the vehicle. Yet, a modern seat belt permits movement of the seat occupant during normal driving conditions or when the vehicle stands still, e.g. the seat occupant leaning forward, by adjusting the used length of the seat belt according to the movement of the seat occupant. It is further known to use a retractor to suddenly and strongly retract the seat belt in case of a collision or imminent collision being detected, since it is beneficial for the seat occupant to be located close to a backrest and a headrest in such a situation. The sudden and strong retraction of the seat belt is certainly uncomfortable for the seat occupant, and may even cause a minor injury to the seat occupant. However, the advantages of being seated close to the backrest and headrest in case of a collision outweigh any discomfort or minor injury.

Document US 2007/0114768 A1 discloses a safety arrangement for detecting the position of an occupant of a seat, which is provided with a seat belt mounted on a retractor and includes a sensor, which measures the length of belt withdrawn from the retractor. The sensor is associated with a processor unit which is associated with a seat position sensor. By determining the position of the seat and by determining the minimum length of belt paid-out from the retractor after the seat belt has been buckled in position, and by determining how additional belt has been paid-out at any incident, the position of the seat occupant relative to an airbag can be determined. If the seat occupant is very close to the airbag, the nature of deployment of the air-bag can be moderated by the processor unit. The invention disclosed in US 2007/0114768 A1 is thus based on the idea of detecting the position of the seat occupant from the amount of belt withdrawn relative to a reference, if the position of the seat is known. This information is used to moderate or inhibit deployment of the airbag, if the seat occupant is very close to the airbag.

Document US 2007/0114768 A1 thus tells how to operate the airbag as a consequence of the position of the seat occupant relative to the vehicle. The document is however silent about how to control the retraction of the seat belt, in case of a collision and/or a risk situation being detected.

### SUMMARY

The object of the present disclosure is to overcome at least one of the disadvantages of the prior art, or to provide a useful alternative.

It is desirable to provide a method for retracting a seat belt, wherein the retraction of the seat belt is controlled by applying a retraction force, in case of a collision and/or a risk situation being detected.

It is further desirable to provide a method not causing unnecessary discomfort to a seat occupant using the seat belt.

Thus, in a first aspect of the present invention there is provided a method for retracting a seat belt of a vehicle, the method comprising the steps of
determining an excessive length L_{Δ} of seat belt pulled out, the excessive length L_{Δ} of seat belt pulled out being the difference between the current length L and the minimum length Lₘᵢₙ of seat belt pulled out, when the seat belt is in use by a current seat occupant, and
in case of detecting a collision and/or a risk situation involving the vehicle, retracting the seat belt by applying a retraction force F, the retraction force F being a function of the excessive length L_{Δ} of seat belt pulled out.

The retraction force is used to pull the seat belt back in case of a collision and/or a risk situation being detected, e.g. a situation of danger or potential danger. The risk situation may be that a collision is imminent or that a driver of the vehicle has lost control of the vehicle. It is then desirable to move a seat occupant back to the favourable position against the backrest, in case the seat occupant e.g. is leaning forwards.

The retraction force F should be differentiated from a pre-tension force used to keep the seat belt tensioned, when the seat occupant moves in the seat during normal driving conditions. The retraction force used is normally a number of times higher than the pre-tension force, e.g. at least twice, preferably at least three times and most preferably at least five times.

The minimum length Lₘᵢₙ of seat belt pulled out relates to when the seat belt is in use by the current seat occupant.

An aim of the present invention is to apply a sufficiently high retraction force, which yet does not cause any unnecessary discomfort to the seat occupant. Purely as an example: If the excessive length L_{Δ} is small, the seat occupant is sitting close to the backrest and the seat belt can be retracted in a gentle manner. However, if the excessive length L_{Δ} is large, the seat occupant is sitting far from the backrest and the seat belt is preferably retracted with a high retraction force to quickly move the seat occupant back to a more favourable position. For the second case, the discomfort caused by the high retraction force is acceptable, since it is important from a safety point of view to position the seat occupant more favourably. On the other side, in the first case, it would be undesirable to apply such a high retraction force. According to the invention, it is hence disclosed that the retraction force is a function of the excessive length L_{Δ} of seat belt pulled out.

It is further to be noted, that there is no need for the method to include a step of determining the position of the seat relative to the rest of the vehicle. Instead, the method will work irrespective of the position of the seat, since the retraction force is a function of the excessive length L_{Δ} of seat belt. Purely as an example, if the seat is in a forward position the absolute length of the used seat belt will be higher than for a more rearward position. However, since the excessive length L_{Δ}, is determined as a difference, its value will not be influenced by the position of the seat.

The excessive length may be determined by measuring, directly or indirectly, a current length L of seat belt pulled out and comparing it to a minimum length Lₘᵢₙ of seat belt pulled out. Alternatively, the excessive length L_{Δ} of seat belt pulled out may be determined by determining the shape of the seat occupant and the position of the seat occupant in relation to the seat, e.g. by means of a camera system or an IR camera system, and thereby indirectly determine the excessive length L_{Δ} of seat belt pulled.

The method may include the steps of:
determining the current length L of seat belt pulled out,
determining the minimum length Lₘᵢₙ of seat belt pulled out,
calculating the excessive length L_{Δ} of seat belt pulled out as the difference between the current length L and the minimum length Lₘᵢₙ of seat belt pulled out.

Since the excessive length L_{Δ} of seat belt pulled out is determined as a difference, there is no need to measure the absolute lengths for the current length L and the minimum length Lₘᵢₙ, as long as the determined lengths relate to each other such that a difference may be calculated.

There are a couple of different lengths of the seat belt, which are used herein:

L_{unused} length of unused seat belt, when hanging at the vehicle wall,
L_{empty} length of seat belt when connected but seat empty,
Lₘᵢₙ minimum length of seat belt when in use,
L current length of seat belt when in use,
L_{Δ} excessive length of seat belt when in use, and
Lₘₐₓ maximum value, physical length of seat belt.

Further, the following relationships are valid:

L_{unused}<L_{empty}

L_{empty}<Lₘᵢₙ

Lₘᵢₙ<=L

L<=Lₘₐₓ

L_{Δ}=L−Lₘᵢₙ

When the seat belt is not used, it hangs against the wall of the vehicle. It has then an unused length, L_{unused}. The length of the seat belt when connected but the seat is empty, L_{empty}, represents a lower limit for the minimum value Lₘᵢₙ. The length of the seat belt when connected but the seat is empty, L_{empty}, will depend on the position of the seat in relation to the vehicle body. However the lowest value is obtained assuming that the seat is in a rearmost position. Even the thinnest person will add to the length, even when leaning fully back, such that the minimum length Lₘᵢₙ of seat belt pulled out always is larger than L_{empty}, as soon as the seat is used and the seat occupant utilizes the seat belt.

The current length L for a particular seat occupant of the seat belt may vary between Lₘᵢₙ and Lₘₐₓ. The lowest value, the minimum value Lₘᵢₙ, is obtained when the seat occupant leans against the backrest. The current length L increases, when the seat occupant leans forwards and decreases when the seat occupant leans backwards. A large and/or thick seat occupant will have longer lengths as regards minimum length Lₘᵢₙ and current length L than a small or thin seat occupant. The lengths are also influenced by the clothes worn by the seat occupant. Purely as an example a thick winter jacket will add more to the length than a T-shirt. The maximum length Lₘₐₓ depends on the physical length of the seat belt and tells how far the seat belt can maximally be pulled out.

The lengths relate to the amount of seat belt being pulled out from e.g. a storage magazine for the seat belt. The portion of the seat belt not being in use may e.g. be stored as wound up on a spool in a retractor.

The current length L of seat belt pulled out may be determined continuously or repeatedly. Thereby, there is always a representative value available. The current length L may for example be determined at least every second, or at least every 1/10 of a second or at least every 1/100 of a second.

Also, the minimum length Lₘᵢₙ may be determined continuously or repeatedly. This may be advantageous, since it may be difficult to know for the individual seat occupant how much time it will take before the seat occupant leans backwards against the backrest. Further, when the seat occupant leans against the backrest, the seat belt may move a little over the body of the seat occupant, and as air may be pressed out of the clothes of the seat occupant. The used length of the seat belt thereby slowly decreases and new values of the minimum length Lₘᵢₙ may successively be provided.

The minimum length may be determined by determining the current length L a plurality of times, and determining the minimum length Lₘᵢₙ of seat belt pulled out as a minimum value of the determined plurality of current lengths L of seat belt pulled out. In that case, also the minimum length Lₘᵢₙ may have a varying value, e.g. being determined as the lowest value so far, e.g. since the particular seat occupant buckled up in the seat.

In order to avoid false detections, it may be required that at least a number of measured lengths, e.g. at least two, or at least two consecutive values, are below the currently determined minimum length Lₘᵢₙ, before the minimum length Lₘᵢₙ is set to a new value.

As an alternative, or a complement, the minimum length Lₘᵢₙ may be determined by recalling it from a data storage memory, e.g. when recalling data about seat settings for a particular seat occupant. In that case, the recalled minimum length Lₘᵢₙ would not reflect the actual clothes being worn by the seat occupant, but would form a good approximation. Such a recalled value may also form a starting point for determining the minimum length Lₘᵢₙ from current length L values, since it is expected that the seat occupant, even if wearing thicker clothes, will have an actual minimum length Lₘᵢₙ being within the stored minimum length Lₘᵢₙ plus compensation for the thicker clothes.

In order to obtain a representative value of the minimum length Lₘᵢₙ it is assumed that the seat occupant, at least once, leans against the backrest. It is highly improbable that the seat occupant would not, at least once, lean against the backrest. However, if the seat occupant has not yet leaned against the backrest, the determined value of the minimum length Lₘᵢₙ will be the best approximation so far, an approximation which will be better the closer the seat occupant has been to the backrest. In that case, the method will still be useful, even though it is preferred that the seat occupant, at least once, has leaned against the backrest.

The method may comprise retracting at least the excessive length L_{Δ} of seat belt pulled out. Since the retraction force is higher than the normal pre-tension force, more seat belt than the excessive length L_{Δ} may be retracted, especially if the seat occupant wears fluffy clothes. In that case, the seat belt may be pulled back as far as the retraction force permits. The seat occupant may in such a case be pressed against the backrest by the seat belt.

Further, even if there is too little time to retract the full excessive length L_{Δ}, it is still useful to retract as much as possible of the excessive length L_{Δ} in order to move the seat occupant as close as possible to the backrest.

The retraction force F may, at least partly, be increasing as a function of the excessive length L_{Δ} of seat belt pulled out. This means that a higher force will be used if the seat occupant is far from the backrest, as compared to if the seat occupant is close to the backrest. The function may be, at least partly, continuously increasing. Alternatively, the function may be stepwise increasing. The whole function, from L_{A}=0 to L_{Δ}=Lₘₐₓ−Lₘᵢₙ, may be increasing, or only part of it.

As an option, a minimal retraction force Fₘᵢₙ may be utilized if the excessive length L_{Δ} of seat belt pulled out is smaller than or equal to a first limit value L_{A}.

As an option, a maximal retraction force Fₘₐₓ may be utilized, if the excessive length L_{Δ} of seat belt pulled out is greater than a second limit value L_{B}. The maximal retraction force Fₘₐₓ may be used to retract as much seat belt as possible with that magnitude of force. As mentioned above, the retracted length may exceed the excessive length L.

If using both the first and the second limit values, the second limit value L_{B} is larger than the first limit value L_{A}.

Further, the second limit value may be set as the same as the first limit value, L_{B}=L_{A}. In that case, the retraction force F will comprise a step function: below and at the limit value, the minimal retraction force Fₘᵢₙ will be applied, and above the limit value the maximal retraction force Fₘₐₓ will be applied. In that case, at least the maximal retraction force Fₘₐₓ will be higher than the normal pre-tension force.

The method may optionally further comprise
determining if a seat occupant is present in a seat to which the seat belt is associated, the seat belt only being retracted if a seat occupant is present in the seat.

If there is no seat occupant present in the seat, there is no need to determine any lengths or to apply a retraction force. Sometimes, a bag or similar can be put in a seat and attached by applying the seat belt through e.g. a handle of the bag. Thereby, it can be avoided that the bag is thrown around in the vehicle in case of a sudden speed change of the vehicle. It may in such a case be favourable to anyway retract the seat belt, although the seat is occupied by an object, and not a person. The term seat occupant as used herein is thus not restricted to human beings, but may also include other objects occupying the seat.

The method may further optionally comprise
determining if the seat belt is buckled up, and determining the minimum length Lₘᵢₙ of seat belt pulled out since it was determined last time that the seat belt was buckled up.

If the seat belt is not buckled up, there is no point in retracting the seat belt with the above-mentioned retraction force in case of a collision.

According to a standard configuration of the seat belt, there is a first belt portion running across the torso of the seat occupant and a second belt portion running over the hip of the seat occupant. If the seat occupant leans forwards, it is primarily the length of the first belt portion which is increased. The above-mentioned method may therefore be performed in relation to the length of first belt portion only, or in relation to both the length of the first and second belt portions.

In a second aspect of the present invention, there is provided a safety arrangement of a vehicle comprising
a seat belt,
a first sensor, for directly or indirectly determining an excessive length L_{Δ} of seat belt pulled out,
a collision detection system,
a retractor, for retracting the seat belt by applying a retraction force F, in case of collision and/or a risk situation involving the vehicle being detected by the collision detection system, and
a processor, which is adapted for determining the retraction force F as a function of the excessive length L_{Δ} of seat belt pulled out.

The first sensor may directly or indirectly measure a parameter corresponding to the length of the seat belt being pulled out. The first sensor may e.g. directly measure the length. Alternatively, it may measure the rotation of a retractor spool being used for storing the seat belt. It may e.g. measure the angular position of the retractor spool. Such sensors are known to the skilled person from e.g. the document US 2007/0114768 A1.

As already explained above, there is no need to include a seat position detector in the safety arrangement according to the invention, since the position of the seat is not used for determining the excessive length L. However, it is an option to include a seat position detector, since it may be used for other tasks, such as determining the distance between the seat occupant and an airbag in the steering wheel or dashboard.

In an embodiment, the first sensor is adapted for determining, directly or indirectly, a current length L of seat belt pulled out, and the excessive length L_{Δ} of seat belt pulled out is calculated as the difference between a current length L of seat belt pulled out and a minimum length Lₘᵢₙ of seat belt pulled out, when the seat belt is in use by a current seat occupant.

The first sensor may also be used for determining, directly or indirectly, the minimum length Lₘᵢₙ of seat belt, e.g. by determining the current length L of seat belt a plurality of times, and determining the minimum length Lₘᵢₙ of seat belt pulled out as a minimum value of the determined plurality of current lengths L of seat belt pulled out. In that case, also the minimum length Lₘᵢₙ may have a varying value, e.g. being determined as the lowest value so far, e.g. since the particular seat occupant buckled up in the seat. The calculations may be made in the processor.

The collision detection system may comprise a remote sensor system, e.g. a camera system, an IR camera system, a radar, a lidar, an ultrasonic sensor system, an accelerometer and/or a vehicle dynamics sensor, such as a steering wheel angle sensor. As an alternative, or in addition, the collision detection system may comprise a contact sensor system, e.g. a piezoelectric sensor. The retraction of the seat belt may be triggered directly by the remote sensor system detecting an imminent collision or another risk situation, and/or the triggering may be based on the actual contact between an object and the vehicle, e.g. an actual collision. The collision detection system is connected to the processor. One or more sensors may be used by the collision detection system. They may be located at various positions in the vehicle depending on type of sensor.

The retractor may be electrical, e.g. utilizing an electrical motor, and may be electronically controlled by the processor, e.g. by sending an electrical signal. Alternatively, the retractor may be mechanical. Alternatively, the retractor may comprise a pyrotechnical means. However, a pyrotechnical means may only be used once. It then has to be replaced by a new pyrotechnical means. It is thus preferred to use a retractor which may be used more than once and does not have to be replaced, e.g. an electrical or mechanical retractor.

This is in particular advantageous if the safety arrangement is activated in case of a risk situation, such as an imminent collision, since in that case the safety arrangement may be easily reset, e.g. if it was activated unnecessarily, e.g. if the collision was actually avoided or was less severe than anticipated. Thereby, the threshold for activating the retractor to retract the seat belt with the above retraction force may be lowered, since there is only a little effort, and/or cost, involved to reset it. The retractor may thus be activated already when a risk for a collision is detected. If instead using a one-time retractor, such as the pyrotechnical means, the vehicle would need to go to e.g. a garage or a workshop to replace the one-time retractor, thus resulting in cost and effort.

The safety arrangement may further comprise a seat belt usage sensor. The seat belt usage sensor is used to see if the seat belt is buckled up.

The safety arrangement may form a part of a larger system of the vehicle, such as an anti-collision system. The safety arrangement may be associated with a driver-assist system, such that the retractor may be activated if it is detected that the driver has lost control of the vehicle, which is an example of a risk situation, since losing control of the vehicle may lead to a collision.

In a third aspect of the invention there is provided a vehicle comprising a safety arrangement according to the above description.

In a fourth aspect of the invention there is provided a use of a safety arrangement for retracting the seat belt, in case of a collision and/or a risk situation being detected, by applying a retraction force F being a function of the excessive length L_{Δ} of seat belt pulled out.

### BRIEF DESCRIPTION OF THE DRAWINGS

The present invention will hereinafter be further explained by means of non-limiting embodiments with reference to the appended drawings wherein:

FIG. 1 illustrates a vehicle with a safety arrangement according to the invention,

FIG. 2 illustrates current length L of seat belt pulled out as a function of time,

FIG. 3 illustrates the retraction force F as a function of current length L of seat belt pulled out, and as a function of the excessive length L_{Δ} of seat belt pulled out, according to a first embodiment, and,

FIG. 4 illustrates the retraction force F as a function of the excessive length L_{Δ} of seat belt pulled out according to a second embodiment.

It should be noted that the appended drawings are not necessarily drawn to scale and that the dimensions of some features of the present invention may have been exaggerated for the sake of clarity.

### DETAILED DESCRIPTION

The invention will, in the following, be exemplified by non-limiting embodiments. It should however be realized that the embodiments are included in order to explain principles of the invention and not to limit the scope of the invention, defined by the appended claims. Details from two or more of the embodiments may be combined with each other.

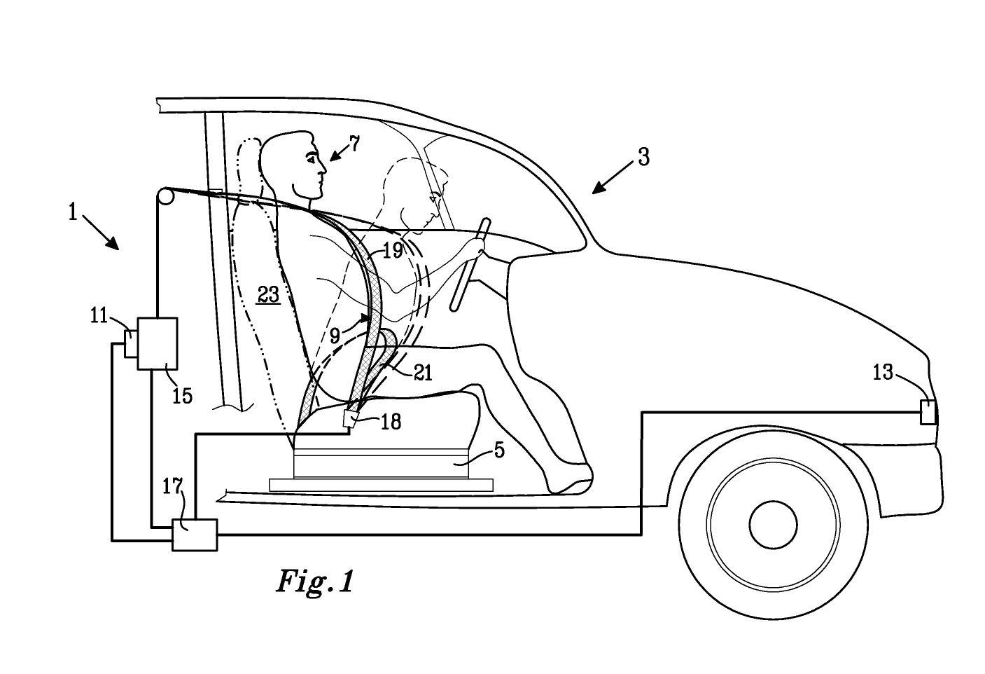

FIG. 1 schematically illustrates a safety arrangement 1 of a vehicle 3. The vehicle 3 comprises a seat 5, in which a seat occupant 7 is seated. The seat occupant 7 has buckled up a seat belt 9, being a part of the safety arrangement 1. The safety arrangement 1 further comprises a first sensor 11 for determining, directly or indirectly, an excessive length L_{Δ} of seat belt pulled, a collision detection system 13, a retractor 15 for retracting the seat belt 9, and a processor 17. Processor 17 may be communicatively coupled to various components of vehicle 3 and safety arrangement 1 to carry out the control routines and actions described herein. Processor 17 may be a microcomputer, including a microprocessor unit, input/output ports, an electronic storage medium for executable programs and calibration values, random access memory, keep alive memory, and a data bus. Processor 17 may receive input from a plurality of sensors, which may include user inputs and/or sensors. Further, processor 17 may communicate with various actuators. In some examples, the storage medium may be programmed with computer-readable data representing instructions executable by the processor for performing the methods described below as well as other variants that are anticipated but not specifically listed.

As an option, the safety arrangement 1 may also comprise a seat belt usage sensor 18, which is used to detect if the seat belt 9 is buckled up. The retractor 15 is adapted to retract the seat belt 9 by applying a retraction force F, in case of a collision and/or a risk situation involving the vehicle 3 being detected by the collision detection system 13.

In the illustrated embodiment, the first sensor 11 is adapted to determine, directly or indirectly, a current length L of seat belt pulled out, e.g. by measuring the rotation of a retractor spool being used for storing the seat belt 9. An excessive length L_{Δ} of seat belt pulled out is calculated as the difference between the current length L of seat belt pulled out and a minimum length Lₘᵢₙ of seat belt pulled out. The calculations may be made in the processor 17. Data about current length L are then sent from the first sensor 11 to the processor 17. The processor 17 is further adapted for determining the retraction force F as a function of the excessive length L_{Δ} of seat belt pulled out.

The collision detection system 13 may comprise a remote sensor system, e.g. a camera system, an IR camera system, a radar, a lidar, an ultrasonic sensor system, an accelerometer and/or a vehicle dynamics sensor, such as a steering wheel angle sensor. As an alternative, or in addition, the collision detection system 13 may comprise a contact sensor system, e.g. a piezoelectric sensor. The retraction of the seat belt 9 may be triggered directly by the remote sensor system detecting a risk situation, such as an imminent collision, and/or the triggering may be based on the actual contact between an object and the vehicle 3, e.g. an actual collision. The collision detection system 13 is connected to the processor 17. One or more sensors may be used by the collision detection system 13. They may be located at various positions in the vehicle 3 depending on the type of sensor.

In case of a collision and/or a risk situation, such as an imminent collision, being detected by the collision detection system 13, the processor 17 sends a signal to the retractor 15 to retract the seat belt 9 by applying the retraction force F.

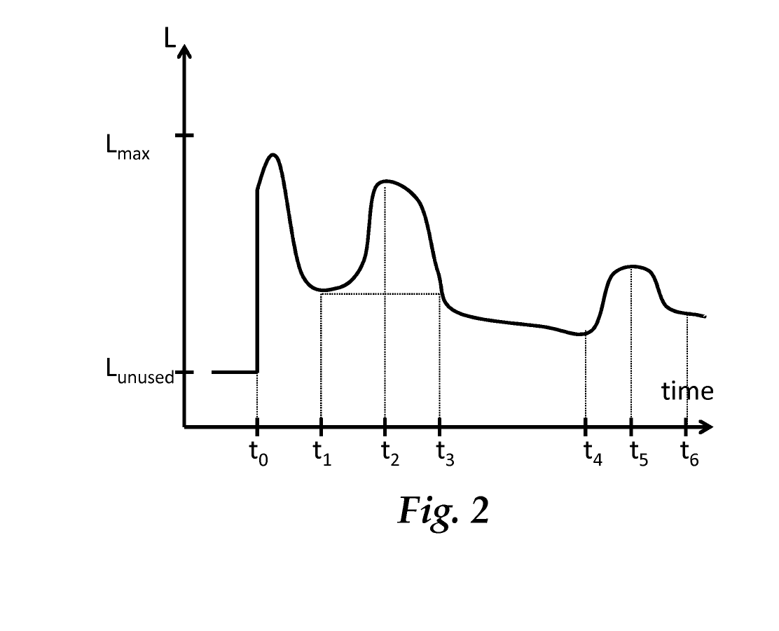

FIG. 2 illustrates an example of a series of measurements made of current length L as a function of time. The current length L is repeatedly measured such that the series in practice can be plotted as a continuous curve.

When the seat belt 9 is not used, it hangs against the wall of the vehicle 3. It has then an unused length L_{unused}. At the time t₀ the seat occupant 7 buckles up, a signal is sent from the seat belt usage sensor 18 to the processor 17. The seat occupant 7 is then seated in the seat 5 and has pulled out the seat belt 9. According to a standard configuration of the seat belt 9, there is a first belt portion 19 running across the torso of the seat occupant 7 and a second belt portion 21 running over the hip of the seat occupant 7. If the seat occupant 7 leans forwards, it is primarily the length of the first belt portion 19 which is increased.

The minimum length Lₘᵢₙ is determined as the hitherto lowest value of the current length L, since the last time the seat belt 9 was buckled up. The value of the minimum length Lₘᵢₙ thus sinks gradually until the time t₁, when the seat occupant 7 leans back against a backrest 23 of the seat 5. Thereafter, the seat occupant 7 leans forward, interval t₁ to t₂, and the values of the current length L increases. Hence the minimum length Lₘᵢₙ remains unchanged. However, the excessive length L_{Δ} of seat belt pulled out increases when the seat occupant 7 leans forward.

The current length L is continuously monitored as long as the seat belt 9 is buckled up. As soon as the current length L is less than the minimum length Lₘᵢₙ, a new value for the minimum length Lₘᵢₙ is provided, in FIG. 2 after the time t₃. Between time t₃ and t₄ the seat occupant 7 sits rather still leaning against the backrest 23. However, as the seat belt 9 moves a little over the body of the seat occupant 7, and as air is pressed out of the clothes, the current length L slowly decreases and new values of the minimum length Lₘᵢₙ are provided up until the time t₄. Then the seat occupant 7 once against leans forward and the current length L increases. The minimum length Lₘᵢₙ is thus maintained as it is. After a while, see time t₆, the seat occupant 7 once again leans backwards against the backrest 23. However, the current length L is longer than the hitherto determined minimum length Lₘᵢₙ. The minimum length Lₘᵢₙ is thus not changed.

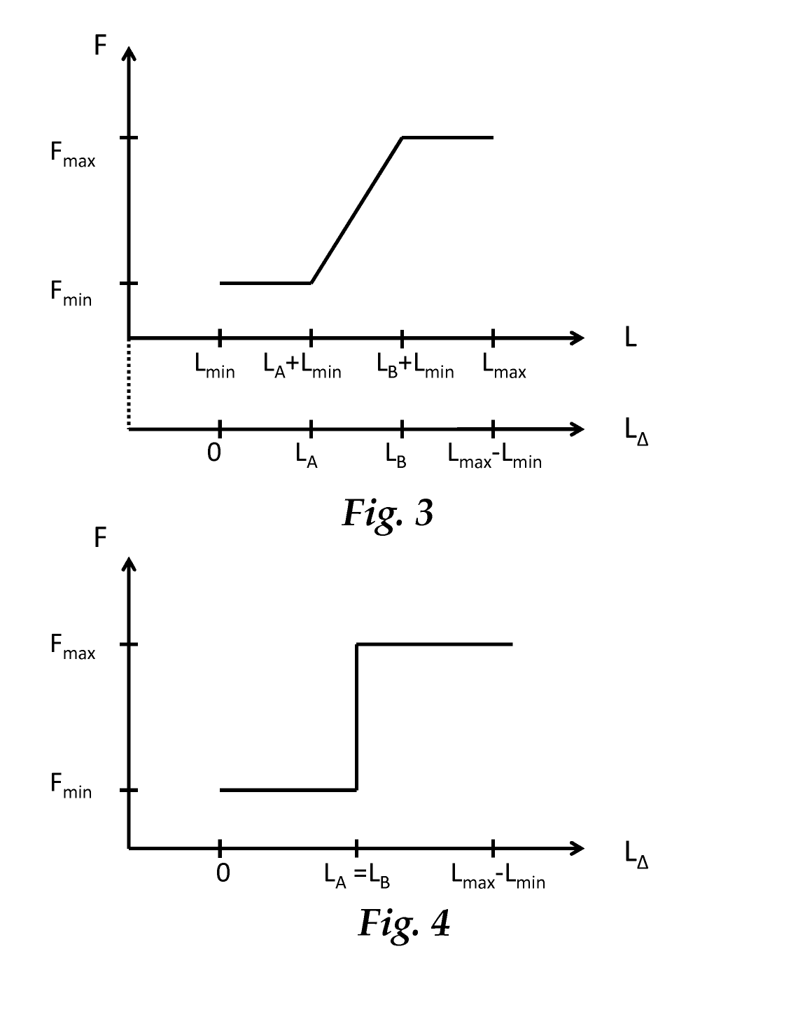

FIG. 3 illustrates the retraction force as a function of the current length L, see upper x-axis, and as a function of the excessive length L_{Δ} of seat belt pulled out, see lower x-axis. As mentioned above L_{Δ}=L−Lₘᵢₙ.

The retraction force F may, at least partly, be increasing as a function of the excessive length L_{Δ} of seat belt pulled out. This means that a higher force will be used if the seat occupant is far from the backrest, as compared to if the seat occupant is close to the backrest.

In the illustrated embodiment, if the excessive length L_{Δ} of seat belt pulled out is smaller than or equal to a first limit value L_{A}, a minimal retraction force Fₘᵢₙ is used to retract the seat belt 9, in case of a collision and/or a risk situation involving the vehicle 3 being detected. If the excessive length L_{Δ} of seat belt pulled out is greater than a second limit value L_{B}, a maximal retraction force Fₘₐₓ is used to retract the seat belt 9, in case of a collision and/or a risk situation involving the vehicle 3 being detected. The second limit value L_{B} is larger than the first limit value L_{A}. Between the first limit value L_{A} and the second limit value L_{B}, the function may be, at least partly, increasing, e.g. linearly increasing as shown in FIG. 3. In other examples, the function may increase non-linearly between the first limit value L_{A} and the second limit value L_{B}.

Further, the second limit value may be set as the same as the first limit value, L_{B}=L_{A}, as in a second embodiment illustrated in FIG. 4. In that case, the retraction force F will comprise a step function: below and at the limit value L_{A}=L_{B}, the minimal retraction force Fₘᵢₙ will be applied and above the limit value, the maximal retraction force Fₘₐₓ will be applied.

Further modifications of the invention within the scope of the appended claims are feasible. As such, the present invention should not be considered as limited by the embodiments and figures described herein. Rather, the full scope of the invention should be determined by the appended claims, with reference to the description and drawings.

1. A method for retracting a seat belt of a vehicle, comprising:
determining an excessive length of seat belt pulled out, said excessive length of seat belt pulled out being the difference between a current length and a minimum length of seat belt pulled out, when said seat belt is in use by a current seat occupant; and
in case of detecting a risk situation involving said vehicle, retracting said seat belt by applying a retraction force, said retraction force being a function of said excessive length of seat belt pulled out.

2. The method according to claim 1, wherein said excessive length of seat belt pulled out is determined by:
determining said current length of seat belt pulled out;
determining said minimum length of seat belt pulled out;
calculating said excessive length of seat belt pulled out as the difference between said current length and said minimum length of seat belt pulled out.

3. The method according to claim 2 wherein said current length of seat belt pulled out and/or said minimum length of seat belt pulled out is/are determined continuously or repeatedly.

4. The method according to claim 2, wherein said current length of seat belt pulled out is determined a plurality of times, and said minimum length of seat belt pulled out is determined as a minimum value of said determined plurality of current lengths of seat belt pulled out.

5. The method according to claim 1, wherein at least said excessive length of seat belt pulled out is retracted.

6. The method according to claim 1, wherein said retraction force is, at least partly, increasing as a function of said excessive length of seat belt pulled out.

7. The method according to claim 1, wherein a minimal retraction force is utilized, if said excessive length of seat belt pulled out is smaller than a first limit value.

8. The method according to claim 7, wherein a maximal retraction force is utilized, if said excessive length of seat belt pulled out is greater than a second limit value.

9. The method according to claim 1, further comprising:
determining if a seat occupant is present in a seat to which said seat belt is associated; and
retracting said seat belt if said seat occupant is present in said seat.

10. The method according to claim 2, further comprising:
determining if said seat belt is buckled up; and
determining said minimum length of seat belt pulled out, since it was determined last time that said seat belt was buckled up.

11. A safety arrangement of a vehicle, comprising:
a seat belt;
a first sensor, for directly or indirectly determining an excessive length of seat belt pulled out;
a collision detection system;
a retractor, for retracting said seat belt by applying a retraction force, in case of a risk situation involving said vehicle being detected by said collision detection system; and
a processor, which is adapted for determining said retraction force as a function of said excessive length of seat belt pulled out.

12. The safety arrangement according to claim 11, wherein said first sensor is adapted for determining a current length of seat belt pulled out, and said excessive length of seat belt pulled out is calculated as the difference between said current length of seat belt pulled out and a minimum length of seat belt pulled out, when said seat belt is in use by a current seat occupant.

13. The safety arrangement according to claim 12, further comprising a seat belt usage sensor.

14. The safety arrangement according to claim 11, further comprising a storage medium programmed with computer-readable data representing instructions executable by the processor for retracting said seat belt, in case of a risk situation being detected, by applying said retraction force determined a function of said excessive length of seat belt pulled out.

15. A vehicle, comprising:
a safety arrangement comprising a seat belt, a first sensor for directly or indirectly determining an excessive length of seat belt pulled out, a collision detection system, a retractor for retracting said seat belt by applying a retraction force in case of a risk situation involving said vehicle being detected by said collision detection system, and a processor which is adapted for determining said retraction force as a function of said excessive length of seat belt pulled out.

16. The vehicle of claim 15, wherein said first sensor is adapted for determining a current length of seat belt pulled out, and said excessive length of seat belt pulled out is calculated as the difference between said current length of seat belt pulled out and a minimum length of seat belt pulled out, when said seat belt is in use by a current seat occupant.

17. The vehicle of claim 16, further comprising further a seat belt usage sensor.
